(19) United States
(12) Patent Application Publication
(10) Pub. No.: US 2022/0227634 A1
(43) Pub. Date: Jul. 21, 2022

(54) MICRON-SIZED SILICA HOLLOW SPHERES WITH RASPBERRY-LIKE STRUCTURES AND A LOW-COST METHOD FOR PREPARATION THEREOF

(71) Applicant: Agency for Science, Technology and Research, Singapore (SG)

(72) Inventors: Jinting Cheng, Singapore (SG); Maria Antipina, Singapore (SG)

(21) Appl. No.: 17/609,071

(22) PCT Filed: May 29, 2020
(86) PCT No.: PCT/SG2020/050316

§ 371 Date: Nov. 5, 2021

(30) Foreign Application Priority Data
Jun. 19, 2019 (SG) 10201905614V

(51) Int. Cl. C01B 33/12

(52) U.S. Cl. CPC C01B 33/126; C01P 2004/04; C01P 2004/03; C01P 2004/61

(57) ABSTRACT

A method of producing hollow inorganic microparticles each having a raspberry-like structure is disclosed herein. The method includes forming a suspension comprising hierarchical microparticles directly from mixing of aqueous reactants, wherein the aqueous reactants are aqueous solutions each containing a reactant for forming the hierarchical microparticles, wherein the hierarchical microparticles comprise CaCO₃ vaterite particles, adding a base, adding a silica precursor, wherein the base is added prior to adding the silica precursor, and removing the hierarchical microparticles with an acid to obtain the hollow inorganic microparticles each having the raspberry-like structure. A hollow inorganic microparticle having a raspberry-like structure produced according to the method is also disclosed herein.

### CROSS-REFERENCE TO RELATED APPLICATION

This application claims the benefit of priority of Singapore Patent Application No. 10201905614V, filed 19 Jun. 2019, the content of it being hereby incorporated by reference in its entirety for all purposes.

### TECHNICAL FIELD

The present disclosure relates to a method of producing hollow inorganic microparticles each having a raspberry-like structure. The present disclosure also relates to such hollow inorganic microparticles.

### BACKGROUND

Microraspberry technology has been explored to produce hollow inorganic (e.g. silica) particles in the micrometer size range having raspberry-like structures. A particle having a raspberry-like structure refers to a particle that has an uneven porous surface or shell, where the uneven surface may arise due to random disposition of other smaller sized particles, rendering the surface of the particle uneven. The hollow micron-sized inorganic particles may be termed microraspberries.

The inorganic (e.g. silica) microraspberries may be produced by having submicron-sized particles grown or decorated on surface of micron-sized particles. While this may be scalable, it may be difficult to realize due to its high cost, i.e. it was estimated that for every kg of microraspberries to be produced, the cost of raw materials alone may amount to about SGD 2.67 million. One example of raw materials may be carboxylate polystyrene particles (about 6 μm in size and without raspberry-like structure) used for deriving, for example, silica microraspberries. Such micron-sized polystyrene particles may be sold at SGD 1.69 million/kg.

While inorganic microraspberries derived such polymeric particles may still be economically viable for use in bead-based detections, wherein only one particle may be used to generate meaningful signal, this does not apply for other applications where a considerable amount of silica microraspberries have to be used. Moreover, in producing inorganic microraspberries from such polymeric particles, additional steps may be required to remove the polymeric particles that were used as template particles to form the silica microraspberries. Such additional step may consume more energy, require access to sophisticated equipments, and/or uses one or more organic solvents that may not sufficiently remove the polymeric particles and thus renders residues there may limit applications of the resultant microraspberries.

There is thus a need to provide for a solution that addresses one or more of the limitations mentioned above. The solution should at least provide for a method of synthesizing hollow inorganic microparticles each having a raspberry-like structure that is at least more economically viable.

### SUMMARY

In a first aspect, there is provided for a method of producing hollow inorganic microparticles each having a raspberry-like structure, the method comprising:
forming a suspension comprising hierarchical microparticles directly from mixing of aqueous reactants, wherein the aqueous reactants are aqueous solutions each containing a reactant for forming the hierarchical microparticles, wherein the hierarchical microparticles comprise CaCO₃ vaterite particles;
adding a base;
adding a silica precursor, wherein the base is added prior to adding the silica precursor; and
removing the hierarchical microparticles with an acid to obtain the hollow inorganic microparticles each having the raspberry-like structure.

In another aspect, there is provided for a hollow inorganic microparticle having a raspberry-like structure produced according to the method of various embodiments of the first aspect.

### BRIEF DESCRIPTION OF THE DRAWINGS

The drawings are not necessarily to scale, emphasis instead generally being placed upon illustrating the principles of the invention. In the following description, various embodiments of the present disclosure are described with reference to the following drawings, in which:

FIG. 1A is a schematic illustration of a conventional hard-templating method suitable for synthesis of submicron-sized silica hollow spheres (submicroSHS) but not micron-sized silica hollow spheres (microSHS).

FIG. 1B is schematic illustration of a hard-templating method for synthesis of microSHS by mixing the micron-sized polystyrene (PS) templating particles with submicron-sized smaller particles to form engineered hierarchical microparticles as the hard templates with increased surface-area-to-volume ratio (micron-sized particles having submicron-sized particles decorated thereon).

FIG. 1C is schematic illustration of the present low cost hard-templating method using micron-sized CaCO₃ vaterite particles as the templating particles. Each of the micron-sized CaCO₃ vaterite particles has submicron-sized small particles on the surface as synthesized, without the need to artificially engineer the submicron-sized particles thereon. In other words, the present CaCO₃ vaterite particles have rough surfaces or high surface-area-to-volume ratio without the need to use the PS submicron-sized particles of FIG. 1B. The high surface-area-to-volume ratio is a parameter for successful production of the resultant raspberry-like structures (microraspberries).

FIG. 2A is a scanning electron microscopy (SEM) image of a 6 μm CaCO₃ vaterite particle with submicron-sized small particles all over the surface. Such a hierarchical structure is advantageously used as the micron-sized hard templates in the present method. Scale bar denotes 1 μm.

FIG. 2B is a magnified SEM image of the CaCO₃ vaterite particle of FIG. 2A. Scale bar denotes 100 nm.

FIG. 3A is a TEM image of a micron-sized silica hollow sphere (microSHS) obtained using the present method, which involves CaCO₃ vaterite particles as the hard templates. A complete particle showing a micron-sized hollow sphere is specifically shown. Scale bar denotes 1 μm.

FIG. 3B is a high-resolution TEM image of the microSHS showing a shell thickness of 109 nm having submicron-sized structures decorated thereon. Scale bar denotes 200 nm.

FIG. 4A is a SEM image of a microSHS obtained using the present method, which involves CaCO₃ vaterite particles as the hard templates. A complete particle of a micron-sized particle with raspberry-like appearance is shown.

FIG. 4B is a high-resolution SEM image of the boxed area on the microSHS in FIG. 4A showing the submicron-sized structures on the particle surface have nano-sized fine features.

FIG. 5A is a plot of the Brunauer-Emmett-Teller (BET) surface area result of the microraspberries.

FIG. 5B is a high-resolution TEM image showing the shell of a microraspberry of FIG. 5A. Scale bar denotes 100 nm.

FIG. 6 shows microSHS developed from a hard-templating method that requires polymeric particles as the hard templates. The left is a SEM image showing an entire microSHS with submicron-sized particles decorated thereon. The right is a TEM image of the microSHS in the left image.

### DETAILED DESCRIPTION

The following detailed description refers to the accompanying drawings that show, by way of illustration, specific details and embodiments in which the invention may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to a method of synthesizing hollow inorganic microparticles each having a raspberry-like structure. Such hollow micron-sized inorganic microparticles may be termed herein microraspberries due to their raspberry-like structure. Advantageously, the method is able to significantly bring down the cost of manufacturing to about 0.0007% of the cost of, for example, producing each kg of microraspberries from polymeric particles. Accordingly, the present method of producing a kg of microraspberries is about SGD 19.75. With this, the present method is able to scale up microraspberries synthesis from, for example, 20 mg to 600 mg, or even a few grams, per synthesis reaction.

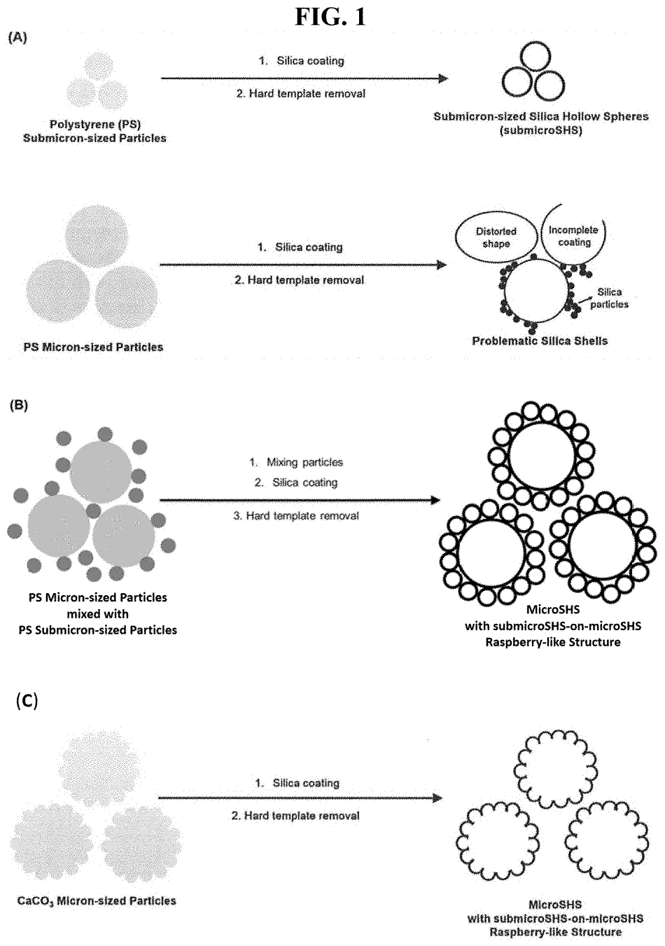

The present method circumvents one or more of materials and steps used in conventional hard-templating approach and hard-templating approach involving engineered hierarchical template. In conventional hard-templating approach, using only micron-sized particles may result problematic (e.g. incomplete formation) silica shells (see FIG. 1A), and in the hard-templating approach involving engineered hierarchical template, submicron-sized particles are therefore added to interact with the micron-sized particles (FIG. 1B). The submicron-sized particles get decorated on the surface of the micron-sized particles forming the engineered hierarchical template to render an increase in the surface-area-to-volume ratio of the template particles, which in turn rendered successful production of microraspberries. The present method circumvents the use of submicron-sized particles. That is to say, the present method is able to produce microraspberries with less raw materials. The expressions “engineered hierarchical template” and “engineered hierarchical template particle” refer to a template particle formed from a micro-sized particle artificially decorated with submicron-sized particles. The term “hierarchical” herein is used to indicate for a particle (i.e. a template) having the structural and morphological features identical or similar to a micron-sized particle decorated with submicron-sized particles. Such structural and morphological features may be termed herein hierarchical structures or hierarchical features. In other words, a hierarchical micron-sized particle produced from the method of the present disclosure can refer to a particle having the same structural and morphological features, but need not be artificially decorated with submicron-sized particles to have such features. An example of a hierarchical particle having a hierarchical structure is the engineered hierarchical template shown in FIG. 1B. An example of a hierarchical particle without artificial decoration of submicron-sized particles is the CaCO₃ vaterite particle involved in the method of the present disclosure.

The present method involves, for example, CaCO₃ vaterite particles, allowing for a straightforward synthesis of the microraspberries. Each of the CaCO₃ vaterite particles may be of micron-sized and may have a surface morphology similar to an engineered hierarchical template particle, i.e. submicron-sized microparticles decorated on micron-sized particles. Said differently, the CaCO₃ vaterite particles of the present method have a high surface-area-to-volume ratio that allows for production of raspberries. As a non-limiting example, the present method, which involves CaCO₃ vaterite particles may be used to produce microraspberries, such as micron-sized silica hollow spheres (microSHS) without even involving submicron-sized particles, decoration of submicron-sized particles on micron-sized particles is advantageously circumvented. In other words, CaCO₃ vaterite particles in the present method are directly usable as the template particles for forming microraspberries.

In the present disclosure, the expressions “micron-sized particles” and “micron particles” are used interchangeably with “microparticles”, and the expressions “submicron-sized particles” and “submicron particles” are used interchangeably with “submicroparticles”. The particles, including the microparticles, submicroparticles, resultant hollow inorganic microparticles, may be substantially spherical. This means that, in some instances, the particles may be perfectly spherical. In some instances, the particles need not be a perfect sphere. The expressions “particle” and “sphere” may be used interchangeably in the present disclosure.

Micron-sized particles, as used herein, refer to particles having an average diameter ranging from 1 μm to 100 μm. Submicron-sized particles, as used herein, refer to particles having an average diameter that is less than 1 μm but at least 1 nm.

In the present disclosure, although the term “diameter” is used normally to refer to the maximal length of a line segment passing through the center and connecting two points on the periphery of a sphere, it is also used herein to refer to the maximal length of a line segment passing through the center and connecting two points on the periphery of particles which are not perfectly spherical. The average diameter may be calculated by dividing the sum of the diameter of each particle by the total number of particles.

Details of various embodiments of the present method and advantages associated with the various embodiments are now described below.

In the present disclosure, there is provided for a method of producing hollow inorganic microparticles each having a raspberry-like structure. The method may include forming a suspension comprising hierarchical microparticles directly from mixing of aqueous reactants. The aqueous reactants may be aqueous solutions each containing a reactant for forming the hierarchical microparticles, wherein the hierarchical microparticles may comprise, for example, CaCO₃ vaterite particles. The method may involve adding a base, adding a silica precursor, wherein the base is added prior to adding the silica precursor, and removing the hierarchical microparticles with an acid to obtain the hollow inorganic microparticles each having the raspberry-like structure. The hierarchical microparticles, without artificially decorating submicroparticles thereon, is used directly as the template particles in the present method. In various embodiments, the hollow inorganic microparticles each having a raspberry-like structure may be hollow silica microparticles each having a raspberry-like structure. As mentioned, the base may be first added, then the silica precursor. Having the base added prior to the silica precursor renders the base better dispersed in the suspension first for a uniform pH therein, which works better for hydrolysis of the silica precursor. If the base is added after the silica precursor, localized high pH (non-uniform dispersion of the base) and prompt hydrolysis of the silica precursor at a localized position may adversely occur, leading to non-uniform hydrolysis affecting the quality of the resultant hollow silica microparticles.

The vaterite particles of the present disclosure is a polymorph of calcium carbonate (CaCO₃), wherein the calcium carbonate has a hexagonal crystal structure unlike other forms of calcium carbonate like calcite and aragonite, which have trigonal and orthorhombic crystal structures, respectively. The vaterite particles has a rough surface morphology and a higher surface-area-to-volume ratio, both comparable to or higher than one afforded by engineered hierarchical template particles, wherein submicron-sized particles are artificially decorated on micron-sized particles. Advantageously, the vaterite particles circumvents the use of such engineered hierarchical template particles, especially the submicron-sized particles.

In the present method, forming the suspension comprising the hierarchical microparticles may comprise dissolving each of the reactant in an aqueous medium. In various embodiments, the aqueous medium may be water. For example, each of the reactant may be separately mixed with water in a beaker or container to form separate aqueous solutions before mixing together. In another example, all the reactants may be mixed together in the aqueous medium, and this mixture may be stirred to allow complete mixing and to prevent agglomeration.

In various embodiments, the base may comprise ammonium hydroxide. The base not only provides for an alkaline pH for the hierarchical microparticles to be coated with an inorganic layer, but may also act as a catalyst for hydrolysis of the inorganic precursor used to form the inorganic layer on the hierarchical microparticles. For example, the inorganic layer may comprise or may be a silica layer. The ammonium hydroxide may be a catalyst for a silica precursor to form the silica layer on the hierarchical microparticles, thereby producing hollow silica microparticles each having a raspberry-like structure when the hierarchical microparticles are removed, leaving behind the silica layer that defines the shell of a hollow silica microraspberry.

In various embodiments, forming the suspension comprising the hierarchical microparticles may comprise, for example, mixing aqueous solutions comprising a calcium chloride solution with a sodium carbonate solution. Said differently, the aqueous reactants used to form the suspension of hierarchical microparticles are a calcium chloride solution and a sodium carbonate solution in this instance. This forms the CaCO₃ vaterite particles as the hierarchical microparticles. The mixing of the aqueous solutions comprising calcium chloride and sodium carbonate may be completed in about 70 seconds or less. The hierarchical microparticles obtained, e.g. vaterite particles, may then be washed using water and by centrifugation. The preparation for synthesis of the hierarchical microparticles and washing may be carried out in 15 mins or less. The total duration for synthesis of the hierarchical microparticles (e.g. vaterite particles) from the starting reactants of, e.g. calcium chloride and sodium carbonate, may be completed in 20 mins or less.

Each of the hierarchical microparticles may comprise an average diameter ranging from 1 μm to 100 μm, 50 μm to 100 μm, 1 μm to 50 μm, 5 μm to 10 μm, 6 μm to 10 μm, 7 μm to 10 μm, 8 μm to 10 μm, or 9 μm to 10 μm. In some instances, the hierarchical microparticle may have a diameter ranging from 5 μm to 10 μm. In certain embodiments, the hierarchical microparticle may comprise a diameter of 6 μm or 10 μm.

The hierarchical microparticles may be monodispersed or polydispersed.

In various embodiments where a silica layer is to be coated on the hierarchical microparticles, mixing the suspension with a silica precursor may be carried out. The mixing of the suspension with the silica precursor may comprise adding the silica precursor to the suspension in a drop-wise manner.

The silica precursor may comprise a silicon alkoxide, or a silicon derivative containing an organic or a polymerizable functional group. For example, the silica precursor may comprise tetraethyl orthosilicate, vinyltrimethoxysilane, methyltrimethoxysilane, dimethyldimethoxysilane, (3-aminopropyl)trimethoxysilane, 3-glycidoxypropyltrimethoxysilane, or 3-methacryloxypropyltrimethoxysilane.

The silica precursor may comprise tetraethyl orthosilicate or vinyltrimethoxysilane according to certain embodiments. In the presence of ammonia or ammonium hydroxide as the catalyst, the silica precursor undergoes hydrolysis, forming silanol groups and the condensation between the silanol groups creates siloxane bridges (Si—O—Si) forming into silica.

In the present method, removing the hierarchical microparticles with an acid renders formation of the hollow inorganic microparticles. Removing the hierarchical microparticles with an acid may comprise (i) contacting the hierarchical microparticles with the acid after adding the silica precursor, and (ii) removing the acid. In various embodiments, the present method may further comprise another step of contacting the hierarchical microparticles with the acid to completely remove the hierarchical microparticles after removing the acid. Advantageously, using an acid suffices to remove the vaterite particles completely without leaving behind residues, which may adversely limit the applications of the resultant hollow inorganic microparticles. Removal of the acid may be carried out by centrifugation.

In various embodiments, the acid may comprise or may consist of a mineral acid or an organic acid. The mineral acid may comprise or may consist of hydrochloric acid. The organic acid may comprise or may consist of ethylenediaminetetraacetic acid (EDTA). The acid may have a concentration ranging from 0.02 M to 1 M, 0.05 M to 1 M, 0.1 M to 1 M, 0.2 M to 1 M, or 0.5 M to 1 M, etc. The acid concentration used can be very low as the CaCO₃ vaterite particles are dissolvable at mild acidic conditions, even for complete removal of the hierarchical microparticles. Nevertheless, an acid concentration of up to 1 M can be used, which suffices, to ensure complete removal of the hierarchical microparticle without adversely affecting formation of the hollow inorganic microparticles. Advantageously, such low concentration ranges render the present method more cost effective due to lower cost of raw materials.

The present method may further comprise washing the hollow inorganic microparticles with water, washing the hollow inorganic microparticles with an alcohol after washing the hollow inorganic microparticles with water, and drying the hollow inorganic microparticles. In various embodiments, the alcohol may comprise or may consist of ethanol.

The synthesis of the resultant microraspberries from the starting reactants of calcium chloride and sodium carbonate may be completed in 4.5 hours or less, wherein synthesis of the resultant microraspberries from the vaterite particles may be completed in 4 hours or less. The preparation for synthesis of microraspberries, which includes removal of vaterite particles and washing may require 2 hours or less.

The present disclosure also provides for a hollow inorganic microparticle having a raspberry-like structure produced according to various embodiments of the method in the first aspect. Embodiments and advantages described for various embodiments of the present method of the first aspect can be analogously valid for the present hollow inorganic microparticle having a raspberry-like structure described herein, and vice versa. As the various embodiments and advantages have already been described above and examples demonstrated herein, they shall not be iterated for brevity.

In summary, the present method provides for synthesis of microraspberries of a few micrometers from CaCO₃ vaterite hard template particles. There is no need to artificially engineer or modify the CaCO₃ vaterite particles. CaCO₃ vaterite particles are hierarchical templates having high surface-area-to-volume ratio, which is a parameter for successful production of microraspberries. The resultant microSHS may have a size in the range of micrometers and has a unique raspberry-like morphology.

The microraspberries produced from the present method has low density and large loading capacity for one or more active ingredients (e.g. drug) due to the hollow space at the micron-scale and submicron-scale and the mesopores. Microraspberries of the present disclosure has a considerably high surface area, and surface-area-to-volume ratio, due to its mesoporous nature and the hierarchical structure of CaCO₃ vaterite particles. The mesopores may allow for diffusion of molecules throughout the porous microraspberries.

In addition, each of the resultant microraspberries has nano-scale features that further provides the higher surface roughness and higher surface-area-to-volume ratio.

The word “substantially” does not exclude “completely” e.g. a composition which is “substantially free” from Y may be completely free from Y. Where necessary, the word “substantially” may be omitted from the definition of the invention.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to a method of producing silica hollow spheres each having a raspberry-like structure (i.e. microraspberries), which involves CaCO₃ vaterite particles as the micron-sized templating particles. The silica hollow spheres may be micron-sized size and hence abbreviated microSHS.

Each of the vaterite particles are micron-sized particles and has submicron-sized particles on the surface, thus having high surface-area-to-volume-ratio. Conventionally, such templating particles had to be achieved by engineering the surface of the micron-sized polystyrene particles previously. For example, submicron-sized polymeric particles were additionally used to decorate the surface of the micron-sized polystyrene templating particles to increase the surface-area-to-volume ratio of the micron-sized templating particles. Without such artificial intervention and additional steps, the micron-sized polystyrene particles alone may not be able to serve as template particles for producing microSHS. On the other hand, the present method involves CaCO₃ vaterite particles as the templating particles, which can be straightaway used as the micron-sized templating particles without the additional artificial intervention and steps due to their unique morphology and structure. Micron-sized silica hollow particles with raspberry-like appearance can be easily produced. Moreover, the present method is more economically viable due to less use of materials and steps, and CaCO₃ vaterite particles is also more cost effective.

When polymeric particles, micron-sized and submicron-sized were used to form hierarchical templating particles, they contributed significantly to the cost of raw materials in producing the microraspberries simply because of the high cost of these polymeric particles. In the market, the micron-sized particles tend to be sold at a few millions of SGD per kg. The microraspberries obtained using such polymer particles as the templating particles therefore cost a few millions of SGD for every kg. While microSHS from polymeric particles may be used in bead-based assays, wherein each individual microraspberry is useful as it generates meaningful information about the sample in the assays, it is not the same for other applications, as a handful (instead of a few) of these microraspberries are simply too expensive to be used. The present method of involving CaCO₃ vaterite particles as the templating particles advantageously renders the total cost of raw materials for producing the microraspberries lower, from a few millions of SGD to about 19.75 SGD for every kg of microraspberries. This breakthrough in cost reduction is possible because CaCO₃ vaterite particles, unlike the polymer particles, can be easily synthesized by mixing the solutions of two common salts, CaCl₂ and Na₂CO₃.

Further, CaCO₃ vaterite templating particles after silica coating can be easily removed. Conventionally, when polymeric particles were used as the templating particles, calcination at high temperature or dissolving the polymeric particles with one or more organic solvents was often employed. However, the one or more organic solvents may fail to completely remove the templating particles, limiting the application of the resultant silica hollow particles. Meanwhile, with the present use of CaCO₃ vaterite particles as the templating particles, complete removal of the templating particles can be easily achieved through dissolution of CaCO₃ vaterite particles in dilute HCl solutions, wherein the HCl removes the CaCO₃ vaterite particles better than an organic solvent removing polymeric particles. This brings down the cost to produce the microraspberries.

The present method and microSHS are described in further details, by way of non-limiting examples, as set forth below.

### Example 1A: Materials

Vinyltrimethoxysilane (VTMS, 98%), ammonia solution (NH₄OH, 28-30%), Calcium chloride (anhydrous powder), sodium carbonate (anhydrous granular ACS) and hydrochloride acid (37%, ACS) are from Sigma-Aldrich. Ethanol (Tech grade, 99%) is from Fischer. All are used without further purification.

### Example 1B: Synthesis of CaCO₃ Vaterite Particles

Into a 100 mL beaker, 10 mL deionized (DI) water and 10 mL 1 M CaCl₂ are sequentially added. The beaker, with a magnetic stirrer bar therein, was placed onto a magnetic mixer for mixing of the solution. 10 mL 1 M Na₂CO₃ was quickly added into the solution and allowed to mix for 70 seconds then the beaker was gently removed from the magnetic mixer and allowed to settle for at least 10 mins. Centrifugation at 3000 rpm was carried out for 2 mins, and the supernatant was then discarded. The particles were wash three times with DI water (3000 rpm, 2 mins) and then resuspended in 10 mL DI water.

### Example 1C: Synthesis of Hollow Spheres with Raspberry-Like Structures

6 mL freshly prepared CaCO₃ particles, 8.42 mL DI water and 600 μL NH₄OH were added into a 30 mL glass bottle. Complete mixing of the reagents were carried out. Then 200 μL VTMS was added drop-wise. The reactants were stirred for mixing at room temperature (e.g. 20 to 40° C.) for 2 hours. The reaction mixture was transferred into a 50 mL centrifuge tube and wash with ethanol (Tech Grade) three times (3000 rpm, 5 mins). 10 mL 0.01 M HCl was added and the suspension was transferred into a 100 mL reagent bottle, sequentially added with 10 mL of 0.02 M, 0.05 M, 0.1 M, 0.2 M, 0.5 M, and 1 M HCl to form respective samples. All samples were stirred for 10 mins after each step of addition. The suspension was transferred into two 50 mL centrifuge tubes, centrifuged (4500 rpm, 5 mins), supernatant discarded, then added 1 mL 3 M HCl to the pellet and suspended the particles to make sure there is no more bubbles generated from the suspension. The particles were washed 3 times with DI water (4500 rpm, 5 mins) and suspended in 6 mL DI water. To get dry particle powder, wash with ethanol was carried out twice, the supernatant was removed and particles were left to dry in 95° C. oven overnight.

### Example 1D: Characterization

Scanning Electron Microscopy (SEM)—Samples were drop cast on clean silicon wafer, dried and coated with gold using JEOL JFC-1300 coater operated at 10 mV for 20 seconds. SEM images were obtained using field emission scanning electron microscopy (FESEM) JEOL FESEM JSM670OF operated at 2 kV with gentle bean.

Transmission Electron Microscopy (TEM)—Samples were drop cast onto TEM copper grids and TEM images were acquired using high-resolution transmission electron microscopy (HRTEM) Philips CM300 FEGTEM operated at 300 kV.

Brunauer-Emmett-Teller (BET) surface area and pore size analysis—Dried particle powder was degassed at 150° C. for 15 hours and then analyzed by Automatic High Resolution Physisorption (Micropore/Mesopore) Analyzer (ASAP2020MP).

### Example 2: Discussion of Present Method and Results

FIG. 1A schematically illustrates the hard templating method used for synthesis of silica hollow spheres (SHS). Such conventional hard templating method tends to be widely used for producing submicron-sized silica hollow spheres (submicroSHS) but it fails in producing SHS when micron-sized templating particles are used. Another hard templating method that successfully produces micron-sized silica hollow spheres (microSHS) with raspberry-like structures (i.e. microraspberries) is shown in FIG. 1B. The micron-sized templating particles were mixed with submicron-sized smaller templating particles and allowed to interact with each other. They formed hierarchical structures with micron-sized particles decorated with the submicron-sized particles therein (i.e. engineered hierarchical templates), and these hierarchical structures, compared to the micron-sized particles of FIG. 1A, have increased surface-area-to-volume ratio. This ratio is a parameter for the successful hard-templating process of the present disclosure. Specifically, the present disclosure involves CaCO₃ micron-sized particles that can be used in a straightforward manner as the templates to produce the microraspberries. The CaCO₃ micron-sized particles in the form of vaterite have hierarchical structures without mixing with submicron-sized particles (see FIG. 1C). The vaterite particles having high surface-area-to-volume ratio are highly suitable for synthesis of the microraspberries. The successful synthesis of microraspberries using the CaCO₃ system demonstrates that the present method is advantageous and the surface-area-to-volume ratio parameter is indeed a parameter that has to be considered in hard templating method.

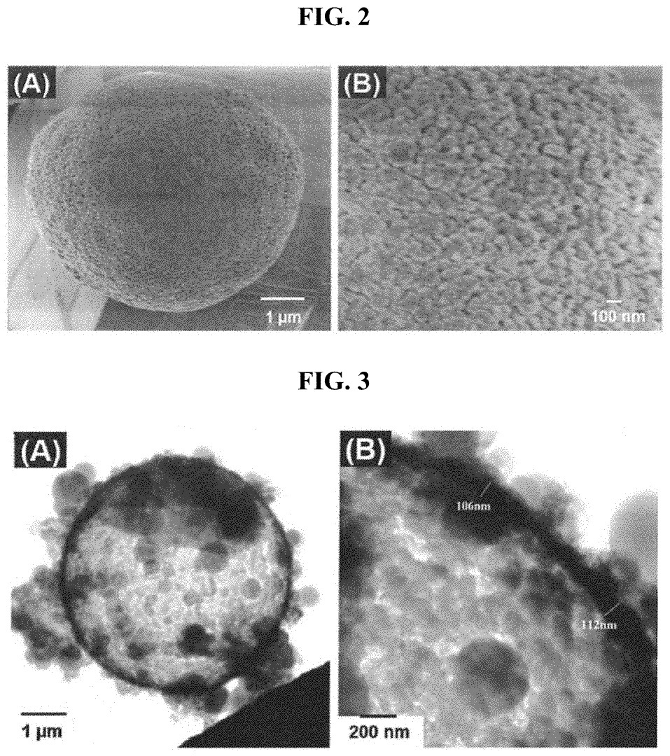

The synthesized CaCO₃ vaterite particles were observed under SEM. FIGS. 2A and 2B clearly show a 6 μm particle having its surface completely covered with submicron-sized smaller particles. This hierarchical structure of the CaCO₃ vaterite particles is highly advantageous for use as the hard templates to produce the microraspberries. In another hard-templating method, polystyrene micron-sized templating particles decorated with submicron-sized smaller particles were engineered to produce a rough surface morphology. Conversely, in the present method, CaCO₃ vaterite particles have such a rough surface morphology. With this feature of CaCO₃ vaterite particles, experiments were carried to determine their use as hard-templating particles for microraspberries synthesis.

When CaCO₃ vaterite particles were used as the hard templates in the present method, micron-sized silica hollow spheres (microSHS) were easily produced through VTMS hydrolysis followed with dissolution of the CaCO₃ vaterite particles using HCl. FIG. 3A shows a complete microSHS and FIG. 3B shows the high-resolution image of the microSHS shell. The main hollow particle has a shell of 109 nm thick decorated with submicron-sized structures on the shell.

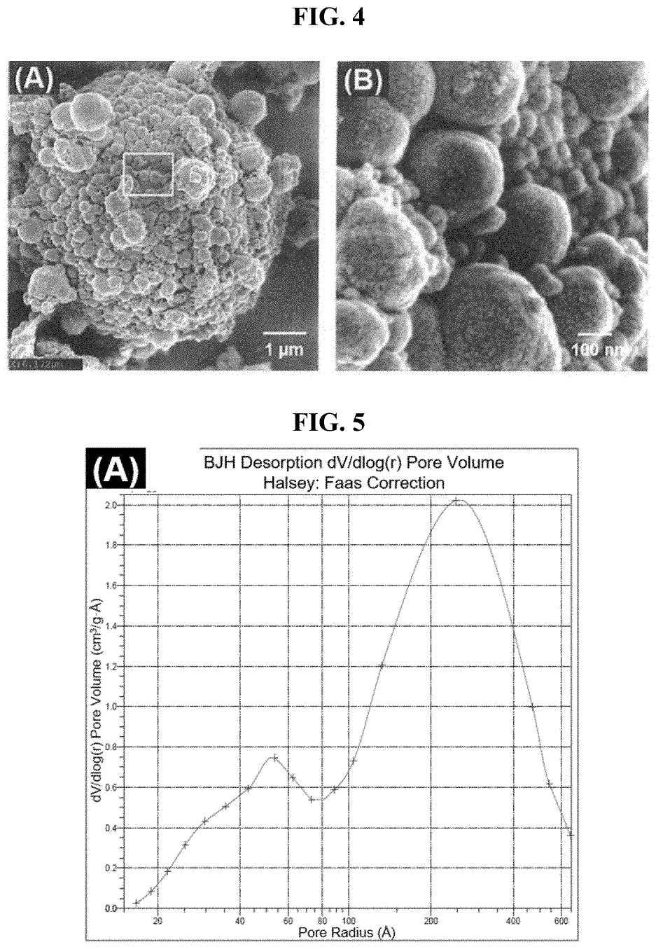

The microSHS were imaged using SEM to check their surface morphology. FIG. 4A clearly shows that the microSHS templated from CaCO₃ vaterite particles have raspberry-like appearance. The microSHS were decorated with submicron-sized particulates on the surface. When taking a closer look, the high-resolution image TEM in FIG. 4B shows that the submicron-sized smaller particles on the surface also have fine features at the nano-scale. These hierarchical structures, having nano-scale features on submicron-scale particles that are on the micron-scale SHS, are further advantageous for deploying the microraspberries in wide applications because they have very rough surfaces and significantly high surface area that are easily accessible, unlike the surface areas inside small mesopores.

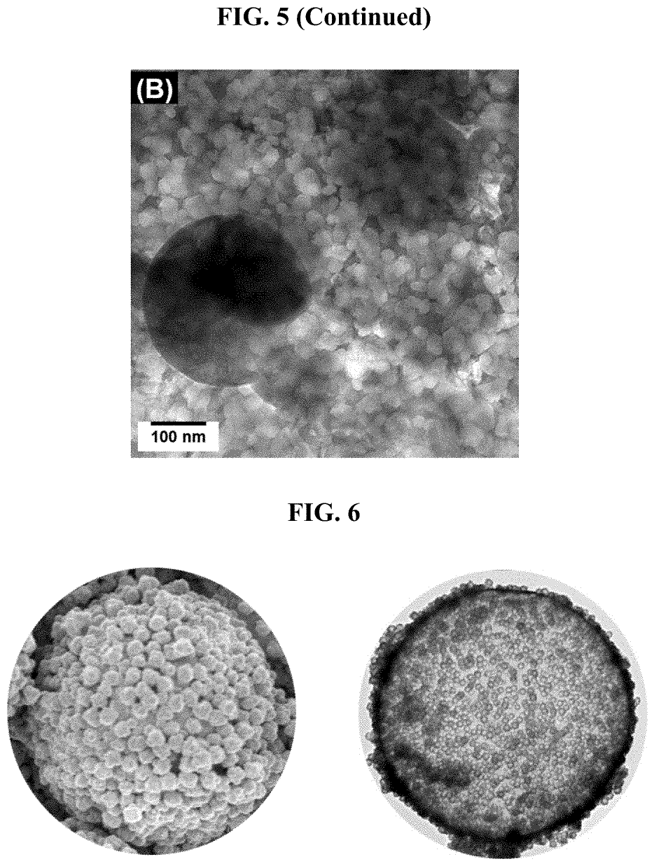

In addition, the pore size, size distribution, and surface area of the microraspberries were analyzed. FIG. 5A shows the BET pore size distribution of the microraspberries. It can be seen that the microraspberries have mesopores of a diameter of 50 nm. This is confirmed by high-resolution TEM of the microraspberry shell, showing big mesopores (FIG. 5B). The BET surface area of the microraspberries is about 117.3 m²/g (with correlation coefficient at 0.999023).

### Example 3: Commercial and Potential Applications

With the above, it has been demonstrated that the microraspberries synthesized using the present method, which involves CaCO₃ vaterite particles are potentially usable for tests and use in all the downstream applications and product development. The synthesized microraspberries serve as a group of new materials that is economically viable for use in a wide range of applications due its significantly low cost and their distinctive properties, which include (1) having raspberry-like hierarchical structure that provides a huge surface area and hierarchical surface roughness at the nano-, submicron- and micron-scale all via one material to any surface when they are applied thereto, (2) having big mesopores that are ideal for loading of large amount of reactants without being limited to any types of reactions as the present microraspberries often do not participate in reactions, (3) having a size in the micrometer range and hence do not suffer from concerns related to nano-sized materials, (4) being made of silica, which is an inert material that is thermally and chemically stable, (5) derived from a major constituent of sand and hence environmentally friendly and biocompatible, and (6) being hollow, low density, light weight, for better suspension in solution and transportation. The present microraspberries can potentially be used in a variety of applications, which include but not limited to, microbead platform for sensing, superhydrophobic coating, catalysis, low density applications like ultrasound imaging, drug loading and delivery, energy generation and storage, heavy metal ion separation, and/or generation of regulated cell interactions due to its surface roughness.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of producing hollow inorganic microparticles each having a raspberry-like structure, wherein each of the hollow inorganic microparticles having the raspberry-like structure comprises a surface having mesopores and having hierarchical structures of nano-scale, submicron-scale, and micron-scale, the method comprising:
forming a suspension comprising hierarchical microparticles directly from mixing of two aqueous reactants, wherein the two aqueous reactants are aqueous solutions each containing a reactant for forming the hierarchical microparticles, wherein the hierarchical microparticles comprise CaCO₃ vaterite particles, wherein the aqueous solutions are a calcium chloride solution and a sodium carbonate solution;
adding a base;
adding a silica precursor, wherein the base is added prior to adding the silica precursor; and
removing the hierarchical microparticles with an acid to obtain the hollow inorganic microparticles each having the raspberry-like structure.

2. The method of claim 1, wherein forming the hierarchical microparticles comprises dissolving each of the reactant in an aqueous medium.

3. The method of claim 2, wherein the aqueous medium comprises water.

4. The method of claim 1, wherein the base comprises ammonium hydroxide.

5. The method of claim 1, wherein each of the hierarchical microparticles comprises an average diameter ranging from 1 μm to 100 μm.

6. The method of claim 1, wherein the hierarchical microparticles are monodispersed or polydispersed.

7. The method of claim 1, wherein the silica precursor is added without any alcohol.

8. The method of claim 1, wherein adding the silica precursor comprises adding the silica precursor in a drop-wise manner.

9. The method of claim 1, wherein the silica precursor comprises a silicon alkoxide, or a silicon derivative containing an organic or a polymerizable functional group.

10. The method of claim 1, wherein the silica precursor comprises tetraethyl orthosilicate, vinyltrimethoxysilane, methyltrimethoxysilane, dimethyldimethoxysilane, (3-aminopropyl)trimethoxysilane, 3-glycidoxypropyltrimethoxysilane, or 3-methacryloxypropyltrimethoxysilane.

11. The method of claim 1, wherein removing the hierarchical microparticles with an acid comprises:
contacting the hierarchical microparticles with the acid after adding the silica precursor, and
removing the acid.

12. The method of claim 11, further comprising another step of contacting the hierarchical microparticles with the acid to completely remove the hierarchical microparticles then removing the acid.

13. The method of claim 11, wherein removing the acid is carried out by centrifugation.

14. The method of claim 1, wherein the acid comprises a mineral acid or an organic acid.

15. The method of claim 14, wherein the mineral acid comprises hydrochloric acid.

16. The method of claim 14 or 15, wherein the organic acid comprises ethylenediaminetetraacetic acid.

17. The method of claim 1, wherein the acid has a concentration ranging from 0.02 M to 1 M.

18. The method of claim 1, further comprising:
washing the hollow inorganic microparticles with water;
washing the hollow inorganic microparticles with an alcohol after washing the hollow inorganic microparticles with water; and
drying the hollow inorganic microparticles.

19. The method of claim 18, wherein the alcohol comprises ethanol.

20. A hollow inorganic microparticle having a raspberry-like structure produced according to the method of claim 1, wherein the hollow inorganic microparticle having the raspberry-like structure comprises a surface having mesopores and having hierarchical structures of nano-scale, submicron-scale, and micron-scale.
